(19) United States
(12) Patent Application Publication
(10) Pub. No.: US 2025/0239113 A1
(43) Pub. Date: Jul. 24, 2025

(54) OPERATION BASED VEHICLE DIAGNOSTICS

(71) Applicant: Innova Electronics Corporation, Irvine, CA (US)

(72) Inventors: Ly Bach, Ho Chi Minh City (VN); Suong Nguyen, Ho Chi Minh City (VN); Thanh Phan, Ho Chi Minh City (VN); Keith Andreasen, Garden Grove, CA (US)

(21) Appl. No.: 18/416,724

(22) Filed: Jan. 18, 2024

(51) Int. Cl. G07C 5/08; G07C 5/00

(52) U.S. Cl. CPC G07C 5/0808; G07C 5/008

(57) ABSTRACT

A diagnostic method for a vehicle includes receiving a signal identifying a selected test from several available tests. Prescribed operational conditions associated with the test are identified and a first data set from the vehicle indicative of vehicle operating conditions is received. The vehicle operating conditions are compared with the prescribed operational conditions to evaluate compliance therebetween. When the vehicle operating conditions comply with the prescribed operational conditions, multiple operating parameters associated with the selected test are identified. A second data set is received from the vehicle including data indicative of multiple operating parameters associated with the selected test. The received second data set is compared with an optimal data set to identify a portion that does not comply with the optimal data set. A most likely solution is identified based on the portion of the received second data set that does not comply with the optimal data set.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

### 1. Technical Field

The present disclosure relates generally to an automotive diagnostic system, and more specifically, to an automotive diagnostic system capable of illustrating multiple diagnostic parameters on a single graphic and actuating diagnostic testing to identify and/or confirm a most likely solution for a diagnostic problem on the vehicle.

### 2. Description of the Related Art

The integration of computer systems into the automobile has resulted in automotive diagnostics including a data analysis component. In this regard, while historical vehicle diagnostics may have relied solely on a mechanic's assessment of what can be seen or heard during operation of the vehicle, the data provided by the contemporary vehicles allows for a much more comprehensive diagnostic assessment of the vehicle.

However, as vehicles evolve and more computers become integrated into the vehicle, using data to diagnose a vehicle may require a nuanced approach. For instance, diagnostic trouble codes (DTCs) are generated by contemporary vehicles when a problem has arisen in one or more components of the vehicle. Retrieving and reviewing the DTC(s) is certainly a useful part of a diagnostic process, particularly when the process is supported by historical data for vehicle specific resolution. However, relying solely on the DTC(s) may lead to ambiguous results, as the DTC(s) may be representative of a symptom based on an underlying, deeper diagnostic condition.

In addition to DTC(s), many modern vehicles may also be capable of generating live data for one or more sensors, systems, or other vehicle components. The live data may be representative of that vehicle component's performance during operation of the vehicle, and thus, the use of live data may be a useful tool when trying to diagnose a vehicle.

The large amounts of data that may be generated by the vehicle may lead to accurate, data-based diagnostic conclusions. However, undertaking the task of analyzing the vehicle data may be beyond the capabilities or interest of the common vehicle owner, and thus, in many instances, problems with the vehicle may be ignored. For instance, live data may be difficult to decipher without a better understanding of the operative relationship between various components. Even professional mechanics may struggle at analyzing the vehicle data to troubleshooting problem. The ability to understand how one piece of diagnostic data may or may not relate to other pieces of diagnostic data may be challenging, and as a consequence, if related data goes unnoticed, it is possible that diagnostic insights or cues may be overlooked.

Furthermore, a diagnostic analysis of the vehicle may be enhanced by causing a prescribed action for one or more vehicle components, such as causing a valve to open or close. The prescribed action may be associated with an expected result, which may be observable in the live data. However, as noted above, being able to digest live data reading in the context of a comprehensive diagnostic data package may prove to be challenging.

Accordingly, there is a need in the art for a diagnostic system that provides an easy to use diagnostic system that may present diagnostic data in a easy to understand format, which may also facilitate processing of live data resulting from prescribed actions as part of a diagnostic assessment of the vehicle. Various aspects of the present disclosure address this particular need, as will be discussed in more detail below.

### BRIEF SUMMARY

Various aspects of the present disclosure are directed toward a vehicle diagnostic system which aims to use OBD2 parameters to diagnose vehicle issues by activating an enforcement module and testing various sensors. The system may collect data related to operational values of the sensor(s) and analyze the collected data to determine whether the sensor's ability to operate is good or bad. The system may provide accurate and reliable diagnostic information to car owners and mechanics, which may be used to identify and fix issues quickly and efficiently. The system may use various tools and technologies to collect and analyze data, including OBD2 scanners, sensors, and data analysis software. By leveraging the power of OBD2 parameters and the latest data analysis techniques, the diagnostic system may be more user friendly and accessible to everyone.

According to one embodiment, there is provided a diagnostic method for a vehicle, with the method comprising the steps of receiving a test selection signal identifying a selected test from a plurality of available tests. The method further includes identifying prescribed operational conditions associated with the selected test and receiving a first data set from the vehicle indicative of vehicle operating conditions. The vehicle operating conditions are compared with the prescribed operational conditions to determine if the vehicle operating conditions comply with the prescribed operational conditions. When the vehicle operating conditions comply with the prescribed operational conditions, multiple operating parameters associated with the selected test are identified. A second data set is received from the vehicle, with the second data set including data associated with the multiple operating parameters associated with the selected test. The received second data set is compared with an optimal data set to identify a portion of the received second data set that does not comply with the optimal data set. A most likely solution is identified based on the portion of the received second data set that does not comply with the optimal data set.

The method may additionally include the step of displaying a graphic depicting a relationship between the multiple operating parameters associated with the received second data set. The graphic may be displayed on a data acquisition and transfer device or on a tablet computer. The diagnostic method may also include the step of incorporating a graphical depiction of the optimal data set on the graphic.

The step of identifying a most likely solution step may include identifying a first most likely solution when the portion of the received second data set that does not comply with the optimal data set is a first portion of the received second data set and a second most likely solution when the portion of the received second data set that does not comply with the optimal data set is a second portion of the received second data set.

The test selection signal is received from a user.

The diagnostic method may also include deriving the test selection signal based on a preliminary assessment of vehicle data. The step of deriving the test selection signal may be based on a comparison of the vehicle data to historical vehicle data. The step of deriving the test selection signal may be based on an algorithmic assessment of the vehicle data. The algorithmic assessment may include an assessment using artificial intelligence. The step of deriving the test selection signal may be based on an algorithmic assessment of at least one of the following factors: vehicle data, a vehicle diagnostic condition, user input, PID data, at least one DTC, live data, and freeze frame data. The step of deriving the test selection signal may include utilizing an algorithm that considers one or more of the factors over a range of operational conditions.

The steps subsequent to receipt of the test selection signal proceed autonomously (e.g., independent of user input) in response to receipt of the test selection signal.

The method may include the step of sending a signal to vehicle to cause a vehicle component to facilitate a desired action, the desired action being associated with an expected vehicle data output.

The method may also include the step of identifying the vehicle based on a data signal received from the vehicle. The identity of the vehicle may be determined based on an electronic vehicle identifying number included in the data signal or based on information in the data signal identifying systems on the vehicle.

According to another embodiment, there is provided an automotive diagnostic method comprising the steps of: receiving a data set from a vehicle, the data set including testing parameter data over a range of operating conditions; comparing the testing parameter data to optimal data over the range of operating conditions and identifying portions of the testing parameter data that comply with the optimal data within a prescribed tolerance as being of an optimal health status and portions of the testing parameter data that do not comply with the optimal data within a prescribed tolerance as being of a non-optimal health status; creating a graphic displaying the testing parameter data over the range of operating conditions; creating a color scheme associated with the testing parameter data by assigning a first color to testing parameter data associated with the optimal health status and a second color to testing parameter data associated with the non-optimal health status; and incorporating the color scheme into the graphic.

According to another embodiment, there is provided a computer program product comprising one or more non-transitory program storage media on which are stored instructions executable by one or more processors or programmable circuits to perform operations for providing vehicle diagnostics. The operations include receiving a test selection signal identifying a selected test from a plurality of available tests. The method further includes identifying prescribed operational conditions associated with the selected test and receiving a first data set from the vehicle indicative of vehicle operating conditions. The vehicle operating conditions are compared with the prescribed operational conditions to determine if the vehicle operating conditions comply with the prescribed operational conditions. When the vehicle operating conditions comply with the prescribed operational conditions, multiple operating parameters associated with the selected test are identified. A second data set is received from the vehicle, with the second data set including data associated with the multiple operating parameters associated with the selected test. The received second data set is compared with an optimal data set to identify a portion of the received second data set that does not comply with the optimal data set. A most likely solution is identified based on the portion of the received second data set that does not comply with the optimal data set.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a system level, schematic overview of a vehicle diagnostic system according to one embodiment of the present disclosure;

FIG. 2 is an exemplary depiction of a plurality of available diagnostic tests available for selection on a user interface;

FIG. 3 is a flow chart associated with a vehicle diagnostic method according to one embodiment of the present disclosure;

FIG. 4 is a graph illustrating RPM data on a horizontal axis, throttle position data on a vertical axis, and long term fuel trim data overlayed on RPM data and throttle position data;

FIG. 5 is an exemplary graphic depicting received mass airflow (MAF) sensor data to ideal MAF sensor data;

FIG. 6 is an exemplary graphic depicting a good relationship between received MAF sensor data and ideal MAF sensor data;

FIG. 7 is an exemplary graphic depicting a bad relationship between received MAF sensor data and ideal MAF sensor data caused by a first most likely solution;

FIG. 8 is an exemplary graphic depicting another bad relationship between received MAF sensor data and ideal MAF sensor data caused by a second most likely solution;

FIG. 9 is an exemplary chart of a specifications database having normal operational ranges and abnormal operational ranges for various components.

FIG. 10 is a flow chart associated with a vehicle diagnostic method according to another embodiment of the present disclosure;

Common reference numerals are used throughout the drawings and the detailed description to indicate the same elements.

### DETAILED DESCRIPTION

The detailed description set forth below in connection with the appended drawings is intended as a description of certain embodiments of data based vehicle diagnostics and is not intended to represent the only forms that may be developed or utilized. The description sets forth the various structure and/or functions in connection with the illustrated embodiments, but it is to be understood, however, that the same or equivalent structure and/or functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities.

Various aspects of the present disclosure relate to vehicle diagnostics specifically adapted to leverage the functionality and data communication capabilities of on-board diagnostics-II (e.g., OBD2) systems to determine a likely operating condition of a vehicle component, e.g., that the vehicle component is healthy/good or unhealthy/bad. The analysis of OBD2 data may be used to conduct passive diagnostics as a substitute for more active diagnostics methodologies. In this regard, the method may be used to identify a most likely solution based on an analysis of OBD2 data independent of actuating a component on a vehicle. The ability to arrive at a most likely solution based solely on an analysis of OBD2 data may be facilitated by knowing what OBD2 data to focus on monitoring and analyzing based on preliminary input, such as symptomatic information identified by a user, information presented on the dashboard of the vehicle, or preliminary OBD2 information retrieved from the vehicle.

The diagnostic analysis of OBD2 data may entail collecting data related to the operating values of one or more components and comparing the collected data with desired specifications for those component(s). The data for several components may be presented in a graphical form, with diagnostic information overlayed onto live data. The graphical depiction may provide better resolution of possible underlying diagnostic issues, as well as being useful as an educational tool.

As used herein, “component” may refer to a single part on a vehicle (e.g., a throttle position sensor, an oxygen sensor, etc.), or to a system in which several parts work together (e.g., a fuel system).

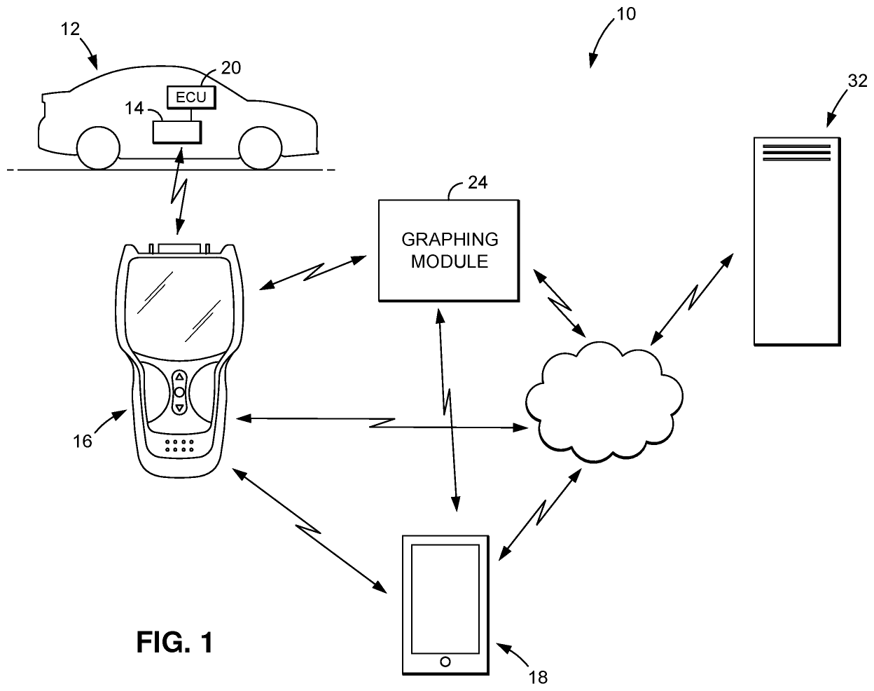

Referring now to FIG. 1, there is depicted a schematic, system-level overview of an exemplary diagnostic system 10. A vehicle 12 may include a data link connector (DLC) port 14 to facilitate data communication between the vehicle 12 and a data acquisition and transfer device (DAT) 16. The DAT 16 may broadly refer to a scan tool, a code reader, a diagnostic dongle, a tablet computer, a smartphone having diagnostic software loaded thereon, or other hardware known by those skilled in the art capable of communicating with the vehicle 12. The DAT 16 may include short-range and long-range wireless communication capabilities to enable communication with local electronic devices, such as a smartphone 18, tablet computer etc., or remote server. The short-range wireless communication capabilities may be facilitated through a short-range communication circuit, which may be capable of communicating via BLUETOOTH, WI-FI, or other communication modalities known in the art. The long-range communication capabilities may be facilitated through a long-range communication circuit, which may be capable of communicating via a cellular communication network. The DAT 16 may include a connector capable of being operatively connectable to the DLC 14 on the vehicle 12 to facilitate data communication between the DAT 16 and the DLC 14. It is contemplated that the operative connection between the DAT 16 and the DLC 14 may be via plug connection (e.g., wired connection) or via wireless connection.

According to one embodiment, an initial step in the process may include identifying the vehicle under test 12. Upon connection of the DAT 16 to the DLC 14, the DAT 16 may initiate communications with an onboard vehicle computer 20 to request an electronic vehicle identification number (VIN) for purposes of identifying the vehicle under test 12. The identity of the vehicle 12 may be used to identify certain testing parameters (e.g., operational conditions or drive cycles), as well as to identify optimal component values for components on that vehicle 12, as will be described in more detail below. The vehicle identity may also be determined through the use of related PIDs (parameters) in OBD2 live data or many other data points, such as monitor status, that may be unique to the vehicle 12, and thus, may be used to determine the identity of the vehicle 12. In this regard, certain portions of the data packet received from the vehicle 12 may be similar to an electronic fingerprint that may be used to determine vehicle identity, or at least certain aspects of the vehicle's identity (e.g., make, model, year, engine, etc.). The data packet may reveal that the vehicle 12 includes certain system(s) and may not include other system(s), which may be used to determine vehicle identity. Along these lines, the system 10 may include a vehicle identity database 22 that includes vehicle identity (e.g., 2012 HONDA ACCORD) matched with systems that are known to be on the vehicle 12, as well as systems that may be known to not be on the vehicle 12. It is contemplated that identification of the vehicle 12 may alternatively be achieved via an input by the user, or via an image captured by the user. For instance, the image may be of the VIN located somewhere on the vehicle 12, an image of a barcode associate with the VIN, or an image of the vehicle 12 which may be analyzed by vehicle identification software to sufficiently identify the vehicle 12 (e.g., identify the year, make and model of the vehicle).

The system 10 may additionally include a graphing module 24, and a remote diagnostic server 32, the purposes of which will be described in more detail below.

It is contemplated that the system 10 may be capable of implementing two modes of diagnostic testing: a first mode of testing based on an OBD2 data stream; and a second mode of testing based on an OBD2 data stream in combination with actuator testing. The details of each mode will be discussed in more detail below.

### Mode 1: Testing Via OBD2 Data Stream (e.g., Passive Testing)

Testing via the OBD2 data stream generally entails receiving a data set (e.g., data obtained over a period of time) from the vehicle 12, which may include data related to several different vehicle parameters (e.g., RPM, throttle position, long term fuel trim, etc.) and analyzing the data to try and identify an underlying problem with the vehicle 12, and an associated most likely solution. The received data set may be compared to a reference data set to identify any deviations of the received data set relative to the reference data set. Any identified deviations may be useful for identifying a most likely solution.

The decision to initiate testing via the OBD2 data stream may be determined based on a noticeable decrease in engine/vehicle performance, in which the user may suspect a problem with the vehicle requiring further analysis. For instance, if a user notices an issue related to fuel consumption, a user may initiate a Long-Term Fuel Trim Test to check the engine performance and to try and pinpoint the component responsible for the system's error/diminished performance and to provide appropriate repair or replacement solutions. In this regard, the system 10 may include various, pre-programmed tests, that correlate different vehicle parameters that are operationally associated with each other.

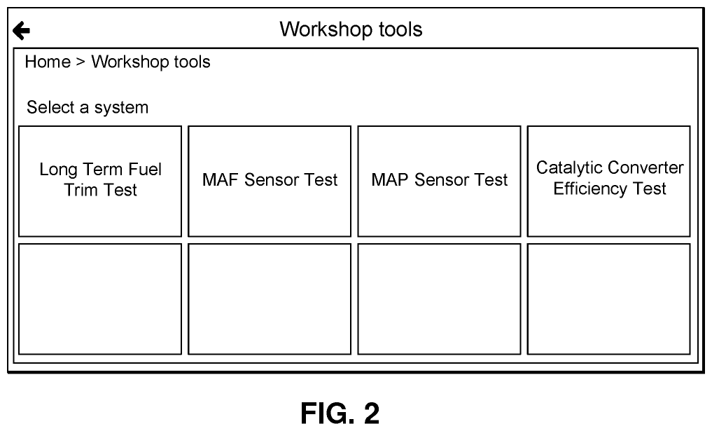

According to one embodiment, the DAT 16 may include a user interface (e.g., touch screen display) that displays several tests that may be executed on the vehicle and which may be selected by the user. Referring now to FIG. 2, there is depicted an example of a user interface showing various tests that may be selected by the user. The exemplary tests include Long Term Fuel Trim Test, MAF (Mass Air Flow) Sensor Test, MAP (Manifold Absolute Pressure) Sensor Test, Catalytic Converter Efficiency Test, although other tests may be included without departing from the spirit and scope of the present disclosure. Each test is associated with particular operating conditions of the vehicle, particular data parameters that are to be monitored, a reference data set for the particular data parameters, and one or more most likely solutions. When the user selects one of the displayed tests, a test selection signal may be received by a controller (e.g., processor and/or other hardware) located locally on the DAT 16 or at a remote device (e.g., remote server 32), with the test selection signal identifying the selected tests from the plurality of tests that are available for selection.

It is also contemplated that the decision to initiate testing via the OBD2 data stream may be prompted by a preliminary analysis of diagnostic data (e.g., DTCs, live data, freeze frame data, etc.) that may suggest a system or component that is not operating at an optimal level, and may require further analysis and testing. The preliminary analysis of diagnostic data may be based on a comparison of the vehicle diagnostic data to historical vehicle data, or alternatively, based on an algorithmic assessment of the vehicle data (e.g., an assessment based on machine learning/artificial intelligence resources). The preliminary analysis may be executed by a preliminary diagnostic analyzer (e.g., a processor and memory unit having necessary data stored thereon). The preliminary diagnostic analyzer may be local to the DAT 16 or may be resource that is remote from the DAT 16 (e.g., on a remote server or electronic device). Once a preliminary diagnostic assessment has been complete, the preliminary diagnostic analyzer may generate the test selection signal based on the preliminary diagnostic assessment. For instance, if the preliminary diagnostic assessment identifies the mass airflow sensor as being a possible problem, the preliminary diagnostic analyzer may generate a test selection signal identifying the MAF Sensor Test for execution.

For more information regarding analysis of diagnostic data for the preliminary diagnostic assessment or for any post diagnostic confirmatory assessment, please refer to the following U.S patents and published patent applications, owned by Innova Electronic Corporation, which is also the owner of the present disclosure: U.S. Pat. No. 6,807,469, entitled AUTO DIAGNOSTIC METHOD AND DEVICE, U.S. Pat. No. 6,925,368, entitled AUTO DIAGNOSTIC METHOD AND DEVICE, U.S. Pat. No. 7,620,484, entitled AUTOMOTIVE MOBILE DIAGNOSTICS, U.S. Pat. No. 8,019,503, entitled AUTOMOTIVE DIAGNOSTIC AND REMEDIAL PROCESS, U.S. Pat. No. 8,370,018, entitled AUTOMOTIVE DIAGNOSTIC PROCESS, U.S. Pat. No. 8,909,416, entitled HANDHELD SCAN TOOL WITH FIED SOLUTION CAPABILITY, U.S. Pat. No. 9,026,400, entitled DIAGNOSTIC PROCESS FOR HOME ELECTRONIC DEVICES, U.S. Pat. No. 9,177,428, entitled PREDICTIVE DIAGNOSTIC METHOD, U.S. Pat. No. 9,646,432, entitled HAND HELD DATA RETRIEVAL DEVICE WITH FIXED SOLUTION CAPABILITY, U.S. Pat. No. 10,643,403, entitled PREDICTIVE DIAGNOSTIC METHOD AND SYSTEM, U.S. Patent Application Pub. No. 2013/0297143, entitled METHOD OF PROCESSING VEHICLE DIAGNOSTIC DATA, U.S. Patent Application Pub. No. 2019/0304208, entitled SYSTEM AND METHOD FOR PROACTIVE VEHICLE DIAGNOSIS AND OPERATIONAL ALERT, U.S. Patent Application Pub. No. 2019/0304213, entitled SYSTEM AND METHOD FOR PROACTIVE VEHICLE DIAGNOSIS AND OPERATIONAL ALERT, U.S. patent application Ser. No. 18/328,289 entitled SYSTEM AND METHOD FOR GUIDED VEHICLE DIAGNOSTICS, and U.S. patent application Ser. No. 18/328,451 entitled VEHICLE DIAGNOSTICS WITH INTELLIGENT COMMUNICATION INTERFACE, the entire contents of each of which is expressly incorporated herein by reference.

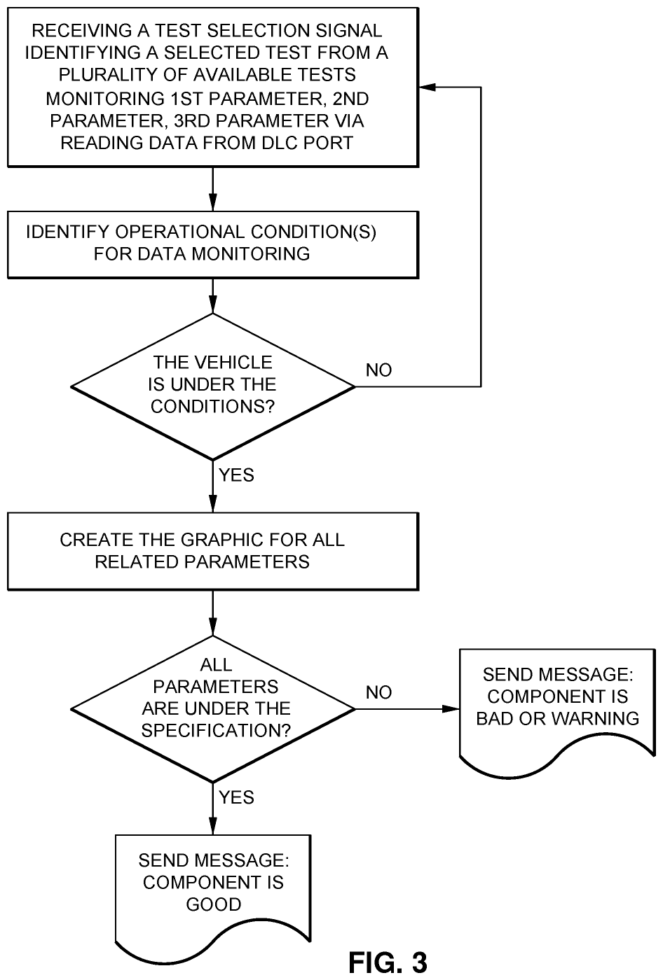

Referring now to FIG. 3, there is depicted an exemplary sequence of steps associated with diagnostic testing via an OBD2 data stream. An initial step includes receiving a test selection signal identifying a selected test from a plurality of available tests, as described in more detail above. The selected test may be associated with several operational conditions that may be required for accurate testing, as well as being associated with several parameters to monitor via the OBD2 data stream. The operational conditions may include pre-testing conditions, i.e., ensuring the engine meets basic operating conditions before starting the test, as well as real-time operational conditions, i.e., ensuring that certain desired operational conditions are met while the data parameter is being monitored. For instance, pre-test conditions may include setting the parking brake, placing the transmission in park or neutral, and letting the engine idle for 5 seconds. Such conditions may also be referred to as static conditions. Real-time test conditions may include starting the engine and allowing the engine to idle for 15 seconds, operating the vehicle in stop and go traffic conditions for 5 minutes with one constant cruise speed ranging from 25 MPH to 45 MPH for 1-2 minutes, slowing the vehicle to 20 MPH, then accelerating to 50 MPH, then returning to normal driving. Such conditions may also be referred to as dynamic conditions. These conditions may be displayed on the DAT 16 or on the smartphone 18, or alternatively on the display screen on the vehicle through operative connection between the DAT 16 or smartphone 18 and the infotainment system on the vehicle 12.

The parameters associated with the test may include operationally related components or operational values that may be associated with a particular vehicle functionality. For instance, operational parameters associated with a long-term fuel trim test may include RPM data, throttle position sensor data, and long-term fuel trim data. Other tests may have other operational parameters uniquely associated with those other tests.

The system may receive OBD2 data and determine if the desired operational conditions are met. If the operational conditions are pre-testing conditions, the monitoring of the parameter data may commence. Once the parameter data is being monitored, the system may ensure any real-time operational conditions are met to ensure valid data is considered during the test. The operational conditions may be monitored by a conditions monitoring circuit, which may be located locally on the DAT, or alternatively, located in a remote resource, such as a remote server or a user's smartphone. If the conditions are not met, an alert may be generated and communicated to the user, either through display on the DAT 16 or via an alert on the user's smartphone 18.

The received data set is compared with an optimal data set by a comparison circuit to identify any discrepancies or deviations between the data sets. The optimal data set may be identified based on the selected test. In other words, once the selected test is known, the optimal data set may be identified. As to the exemplary long-term fuel trim test, the optimal data set may include optimal long-term fuel trim data associated with certain RPM data and certain TPS data. The optimal data set may not only identify optimal data, but may also identify data associated with a cautionary status, as well as data associated with an unhealthy status. The optimal data set may be stored on the remote server 32, on the DAT 16, or on the smartphone 18, and may be stored such that the optimal data set is associated with the selected test. In this regard, once the selected test is identified (in response to receipt of the test selection signal), the optimal data set can be quickly and easily identified. The comparison circuit may also be located on the remote server 32, on the DAT 16, or on the smartphone 18.

The discrepancies between the received data and the optimal data may be indicative of a most likely solution. The most likely solution may be identified based on the portion of the received data set that does not comply with the optimal data set. In this regard, not only does the comparison circuit look to identify any discrepancy between the received data and the optimal data; rather, the comparison circuit conducts a closer comparison to determine where the discrepancy occurs (e.g., at idle or at 3500 RPM), as well as identifying the nature the discrepancy (e.g., the magnitude of the received data was far below/above the optimal data, etc.). For instance, the received data may define a particular data profile which may be compared to a data profile defined by the optimal data. A most likely solution may be identified not only based on a deviation in the received data profile relative to the optimal data profile, but based on where that deviation occurs within the data profile. In this respect, the determination of the specific most likely solution from a variety of possible most likely solutions may be based on the particular operating conditions when the discrepancy occurs. For instance, if the discrepancy occurs at a first operational condition, the most likely solution may be a first most likely solution, and if the discrepancy occurs at a second operational condition, the most likely solution may be a second most likely solution. Stated differently, the step of identifying a most likely solution step may include identifying a first most likely solution when the portion of the received data set that does not comply with the optimal data set is a first portion of the received data set and a second most likely solution when the portion of the received data set that does not comply with the optimal data set is a second portion of the received data set.

The method may additionally include the step of displaying a graphic depicting a relationship between the multiple operating parameters associated with the received data set. The graphic may be displayed on a DAT 16 or on a smartphone/tablet computer 18. It is also contemplated that the graphic may incorporate a graphical depiction of the optimal data set to facilitate a visual comparison between the received data and the optimal data.

The graphic may be created using the graphing module 24 to show the relative relationship between certain operational parameters. The graphing module 24 may include computer instructions executable via computer hardware, such as processors, etc., to arrange the receive vehicle parameter data in a prescribed layout. The computer hardware and software associated with the graphing module 24 may be located on the DAT 16, the smartphone 18 or the remote server 32. In one embodiment, the graphing module 24 may include a template that is filled in with vehicle parameter data as it is received. The parameters included on the graphic may be associated with the test that is being conducted. In other words, each test may have PIDs that are mutually related, such that operation of a component may be inferred through the correlation of any change in the related parameters.

Data received by the DAT 16 may be temporarily stored locally on the DAT 16, or alternatively, uploaded to a remote device, such as a remote server 32, smartphone 18, computer, or the like, for further analysis, as will be described in more detail below. In one embodiment, the destination of the received data may be sent to a location that can facilitate comparison of the received data to the preferred operational values found in the specifications database.

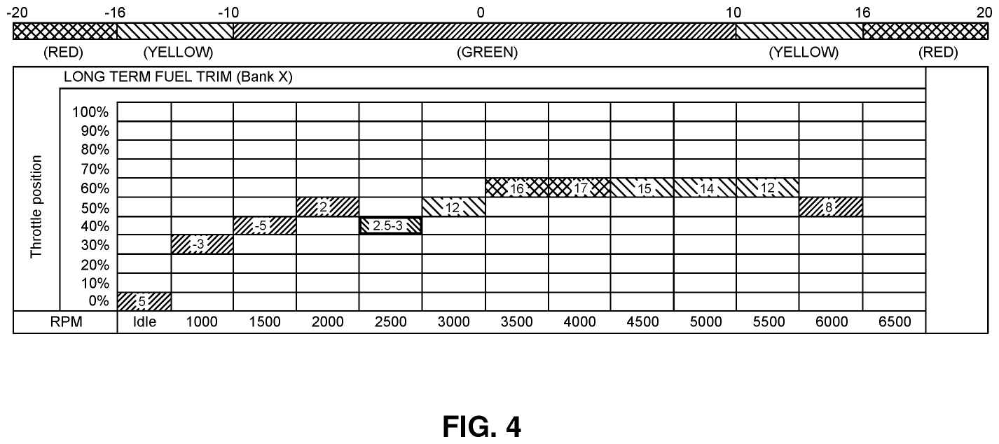

FIG. 4 shows an exemplary graphic associated with the long-term fuel trim test, which may be created using the graphing module 24, with TPS values on a vertical axis and RPM values on the horizontal axis. It is contemplated that the parameters assigned to the horizontal and vertical axes may be defined by the test that is being conducted. In the specific example depicted in FIG. 4, the minimum RPM magnitude on the horizontal axis is an idling magnitude. Adjacent the idling magnitude is 1000 RPM, followed by increases of 500 RPMs along the horizontal axis (e.g., 1500, 2000, etc.). Each RPM magnitude is associated with a vertical column. The throttle position scale on the vertical axis starts at 0% and then increases in 10% increments, with each increment being associated with a respective row.

The rows associated with the throttle positions extend through the columns associated with the RPMs to form a grid of boxes. The box associated with the throttle position at a given RPM may be filled-in, shaded, or otherwise denoted to indicate a coordinate associated with the throttle position at a given RPM, e.g., (RPM, TPS). For instance, at the idling RPM, the throttle position is 0%, and thus, the box associated with the idling RPM and the 0% throttle position is filled in. At 1000 RPM, the throttle position is 30% and thus, the box associated with 1000 RPM and the 30% throttle position is filled in. The box associated with the current, real-time RPM and throttle position may be shaded a different color, and/or may have a bold outline to allow for easy recognition of the real-time data. In the exemplary embodiment, the real-time data value is associated with 2500 RPM and a 40% throttle position. As the RPM and/or throttle position change, the location of the bolded box will also change.

In addition to providing information regarding the RPM and throttle position, the chart may also include information related to a third parameter, which in the exemplary graphic is long-term fuel trim, which may refer to an average of how an onboard computer has been balancing the fuel mixture over time. The long-term fuel trim value may provide useful insight into how the fuel mixture is being corrected to compensate for changes in the air/fuel ration that may be occurring inside the engine. The long-term fuel trim value may appear as the number inside each shaded box. According to one embodiment a value of −10 to 10 is preferred, while a value between −16 to −10 and from 10 to 16 may be indicative of a condition which warrants caution, while values outside of those ranges, e.g., −20 to −16 and from 16 to 20 would be indicative of a bad condition.

When the fuel trim values are too far positive (e.g., from 10-20), it may be indicative of the engine management having measured too much oxygen (lean) and is compensating by adding fuel. In this instance, possible fixes may include the mass airflow sensor being dirty or malfunctioning, a vacuum leak, oxygen or airflow sensor malfunction, exhaust leak near oxygen or airflow sensor, partially plugged fuel injector(s), fuel line restriction, low fuel pressure, or fuel pump malfunction. Conversely, when the fuel trim values are too far negative, it may be indicative of the engine management system having measure a lack of oxygen conditions (rich) and is compensating by subtracting fuel. In this instance, possible fixes may include the mass airflow sensor being dirty or malfunctioning, a worn engine, exhaust restriction, leaking fuel injector, malfunction fuel pressure regulator, EVAP system fault, or high fuel pressure.

The long-term fuel trim associated with each filled in box is presented in that box. In other words, each shaded box includes a number located within that box, and that number is representative of the long-term fuel trim for the corresponding RPM and throttle position. The shading of the box may be of a color associated with the long-term fuel trim. For instance, green shading may be used for preferred long-term trim values, while yellow may be used for cautionary long-term trim values, and red may be used for bad long-term trim values. The color of the box associated with the current RPM and throttle position may be blue, or a different color, to allow for quick and easy perception of that box from the other boxes.

With regard to the exemplary long-term fuel trim test, when the RPM changes, it is expected that the TPS needs to be adjusted accordingly, which also results in expected changes in LTFT values. On the other hand, if TPS changes, RPM and LTFT will also be affected. If the changes are outside the permissible range specified in the specifications, this can help to determine a likely malfunction.

As such, the graphic may be very useful to help identify a problem on the vehicle. In this regard, a quick review of the graphic, and in particular, the colors associated with the underlying data, may help to identify a problematic component or operating conditions that lead to cautionary vehicle conditions. In the exemplary graphic, a red color may be associated with the long-term fuel trim when the RPMs are 3500 and 4000, with the throttle position being at 60%. The graphic also reveals that the throttle position never rises above 60%, and perhaps an increased throttle position, e.g., greater than 60%, would be needed to provide better long-term fuel trim data under those conditions. Thus, systems or components related to the throttle position (e.g., throttle valve and throttle position sensor) may be faulty.

In certain embodiments, the most likely solution may be identified without displaying the graphic. In this regard, the identification of the most likely solution may be determined based on a comparison of the received data set to the optimal data set. Thus, the display of the graphic may not be required. However, it is understood that the graphic may be an extremely useful teaching tool to help mechanics better understand vehicle diagnostics.

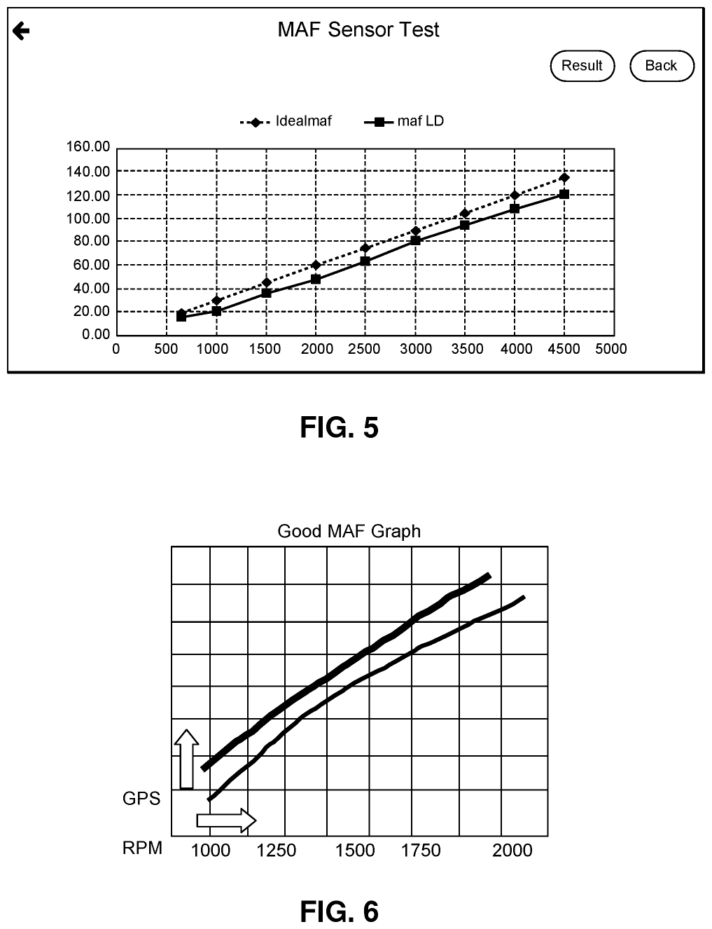

Referring now to FIGS. 5-8, there is depicted another example of diagnostics through the use of OBD2 data, and more specifically, diagnostic analysis of a mass airflow sensor test. The mass airflow sensor is a critical sensor used by the vehicle ECU to calculate the amount of fuel to inject into a cylinder. As described in more detail above, initiation of the test may be in response to selection of the test by a user, or alternatively, the test may be automatically initiated in response to preliminary diagnostic analysis of vehicle data.

Once the system receives the test selection signal associated with the mass airflow sensor test, associated operational conditions for the mass airflow sensor test may be displayed to the user. When the operational conditions are met, an OBD2 data set may be received and analyzed. Ultimately, the test will gather actual mass airflow sensor readings at various RPMs, and compare the actual mass airflow sensor readings to ideal mass airflow sensor readings for those RPMs. The ideal mass airflow sensor readings may be calculated according to a formula which includes four different parameters, namely: 1. Engine displacement (ED); 2. Engine RPM (ER); 3. Intake air temperature (IAT); and 4. Air absolute pressure (AP). The formula may include:

Ideal MAF (lb/min)=[(ED*61.02*ER/3470]*2.7*[AP/(IAT+459.67)]*0.82

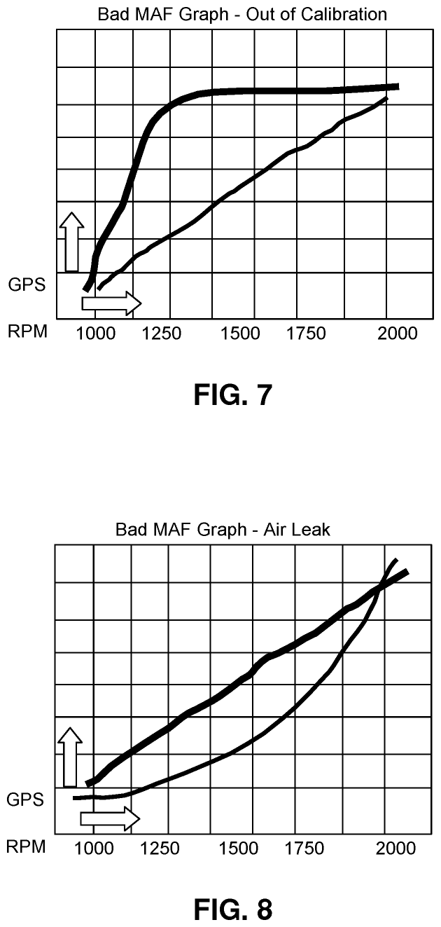

At every RPM checkpoint (e.g., idle, 500, 1000, 1500, etc.), the ideal mass airflow value is calculated and compared to the actual mass airflow value. The actual mass airflow data should be parallel to the ideal mass airflow data, as shown in FIGS. 5 and 6. If the actual mass airflow data is significantly higher or rises too sharply relative to the ideal mass airflow data, as shown in FIG. 7, such a discrepancy may be attributable to a mass airflow sensor malfunction, or a turbocharger/supercharger having a problem. If, on the other hand, the actual mass airflow data is lower than the ideal mass airflow data, as shown in FIG. 8, such a discrepancy may be attributable to the mass airflow sensor being dirty or a vacuum leak. Thus, the location of the discrepancy (e.g., actual data being above the ideal or below the ideal; deviations at certain RPMs, etc.) may help to identify a most likely solution from a plurality of possible most likely solutions.

A conclusion of a good/optimal health status may be concluded when the received data conforms to the optimal data. In this regard, when the received data falls within a defined tolerance or range, the received data may be considered to conform to the optimal data. As such, the received data does not need to be identical to the optimal data to arrive at a healthy status. Furthermore, it is also contemplated that various characteristics of the data profiles may be used to determine whether the received data conforms with the optimal data, such as rate of change (e.g., slope−direction of slope and/or magnitude of slope) of the data in a given data profile. The comparison of the received data to the optimal data may entail comparing a rate of change (e.g., slope) of the received data to the rate of change of the optimal data. Other data comparison characteristics known in the art may also be employed.

The exemplary analysis and related graphics incorporates data related to three vehicle parameters on a single chart. As previously described, the three vehicle parameters each relate to the potentially faulty component. However, in some instances, a potentially faulty component may have several vehicle parameters related thereto, and thus, the determination of which three parameters to monitor and use in creating the graphic may be predetermined. For instance, each potentially faulty component may be associated with predetermined sets or groups, with each set or group including three vehicle parameters. The predetermined groups may be ranked based on historical data. For instance, if a potentially faulty component is associated with four groups (e.g., group A, group B, group C, and group D), the groups may be ranked based on historical success rate, or alternatively, historical usage rate. Thus, when the system is deciding which of the four groups to select, the system may autonomously select the group with the highest ranking. Alternatively, the groups may be presented to the user on a display (such as on the DAT 16, smartphone 18, computer, etc.) and the user may select one of the available groups. As yet another alternative, an artificial intelligence module may make the selection based on a comprehensive assessment of several factors, such as vehicle identification (year, make, model, engine), diagnostic data, environmental factors, vehicle age, historical data for similar vehicles, etc.

In another embodiment, the three vehicle parameters are determined based on a temporary analysis of vehicle data related to the potentially faulty component. For instance, the system may include a group of two vehicle parameters which may be monitored, and based on the data received in relation to the two vehicle parameters, the system may determine the third vehicle parameter. In this regard, the system may include predetermined rules for selecting the third vehicle parameter among multiple possible vehicle parameters based on the data monitored for the first and second vehicle parameters. For instance, one rule may be that if the first vehicle parameter value is within X-Y while the second vehicle parameter value is within A-B, then select third vehicle parameter option 1; if, on the other hand, the first vehicle parameter value is within V-W and the second vehicle parameter value is within C-D, then select third vehicle parameter option 2. Another rule may be that if the first vehicle parameter magnitude is increasing while the second vehicle parameter value is decreasing, then select third vehicle parameter option 3. Thus, the choice of the third vehicle parameter may be based on certain data values of the first and second vehicle parameters, or the rate of change of the first and/or second vehicle parameters, or the direction of change of the first and/second vehicle parameters.

It is also contemplated that the determination of the third vehicle parameter may be based on the coordinates of the first and second vehicle parameters. In this regard, the first and second vehicle parameter data may be preliminarily charted using the data values as coordinates (e.g., first parameter value at time N, second parameter value at time N), and based on the layout of the coordinates, the system may determine the third vehicle parameter. In this regard, the coordinates in the grid may be associated with different third vehicle parameter options. For instance, an upper half of the grid may be associated with a third vehicle parameter option 1, while the lower half of the grid may be associated with a third vehicle parameter option 2. If more coordinates are in the upper half of the grid, the system may select third vehicle parameter option 1, and if more coordinates are in the lower half of the grid, the system may select third vehicle parameter option 2.

In this regard, the ability to select the third vehicle parameter using one of several different methods may allow for adaptability and flexibility based on the resources available, the experience of the user, and the data that may be available. In this regard, a more experienced user may want to make the decision himself, while a more novice user may want to the decision made for him.

In one embodiment, and referring now to FIG. 8, the optimal data may include a normal range of expected values and one or more abnormal ranges of expected values. The normal range may apply to most vehicles and driving conditions, while the abnormal ranges may apply to a limited number of vehicles or driving conditions. For instance, new vehicles may operate more optimally than the average-aged vehicle, and older vehicles may operate less optimally than the average-aged vehicle. Thus, newer vehicles may be subject to an abnormal range associated with better-than-normal expected values, while older vehicles may be subject to an abnormal range associated with worse-than-normal expected values.

The abnormal range may also be associated with environmental conditions, such as certain road grades (e.g., steepness), temperature, precipitation, air quality, etc. Each factor may be associated with one or more prescribed thresholds associated with an abnormal range of expected values. If the magnitude of a given factor warrants use of the abnormal range, the system 10 may use the abnormal range in the calculation.

The use of the abnormal range may allow for justifiable adjustment of the expected values, which may yield more accurate results when comparing to the data received from the vehicle 12.

In addition to the foregoing, it is contemplated that various aspects of the present disclosure may relate to optimization of a desired vehicle parameter, which may be operationally related to one or more related parameters. Thus, to achieve optimal operation of the desired vehicle parameter, adjustments may be made to the related parameters to achieve the sought after effect on the desired vehicle parameter.

For instance, in the case of vehicle racing, it may be desirable to optimize certain parameters (e.g., air input, fuel injection, etc.) to achieve certain operational objectives, such as enhanced torque or increased top-end speed. In other instances, other parameters may be optimized to enhance vehicle responsiveness or handling. In the case of day-to-day driving, it may be desirable to optimize a parameter such as fuel consumption to minimize fuel costs as well as to reduce negative environmental impacts that may be associated with operating the vehicle. Thus, to achieve optimization of a desired vehicle parameter, adjustments to the related parameters may be made.

According to one embodiment, the related parameters associated with a particular desired optimized parameter may be identified, as well as identification of the types of adjustments that may be implemented in connection with the related parameters to achieve a targeted value (e.g., optimization) of the desired parameter. That is to say, if someone wants Parameter A to be of a certain value (or within a range of values), adjusting Parameter B by an amount X and Parameter C by an amount Y may help to achieve that end. It is contemplated that the adjustments may be identified over a range of operating conditions.

In one particular embodiment, a machine learning model may be used to implement the optimization process. In this regard, a controller may apply the machine learning model to a set of vehicle data along with a targeted value for the desired parameter, with the output of the machine learning model being the value(s) for one or more of the related parameters. Such a machine learning model may be trained using historical data sets and historical adjustments to related parameters, as well as the actual effect on the desired parameter. By training a machine learning model with this kind of training data, the machine learning model may recognize, for a given set of related parameter data, which adjustments are the most effective and/or efficient to achieve a desired effect of the desired parameter data. The machine learning model may implement various mathematical functions to achieve the desired optimization. For instance, the machine learning model may facilitate incremental optimization, rate-of-change optimization, greatest-variance optimization, etc.

The process of incremental optimization may include making a first adjustment to a related parameter, and then data for the desired parameter and the related parameters may be received. Based on that updated data, a second adjustment may be made, and then new data for the desired parameter and related parameters may be received. The process of making an adjustment, receiving updated data, and making a subsequent adjustment based on the received data may proceed continuously until the desired parameter meets a prescribed operational value or threshold.

Rate-of-change optimization may refer to identifying which adjustments to the related parameters may bring about the quickest desired change to the desired parameter. Thus, historical data regarding the time to achieve the sought after change based on particular changes to the desired parameters may be fed into the mathematical model to train the model for rate-of-change optimization.

Greatest-variance optimization may monitor the related parameter data and compare the received related parameter data to optimal parameter data to identify one or more parameters that have real data that is of greatest variance relative to the optimal parameter data. The one or more parameters having significant variance between the real data and optimal parameter data may be the parameters which are varied to achieve the optimization. In one embodiment, the parameter having the greatest variance may be the parameter that is varied, whereas in other embodiments, any parameter having a variance that falls outside of a prescribed threshold or range may be varied.

### Mode 2: Testing Via OBD2 Data Stream and Actuator Test

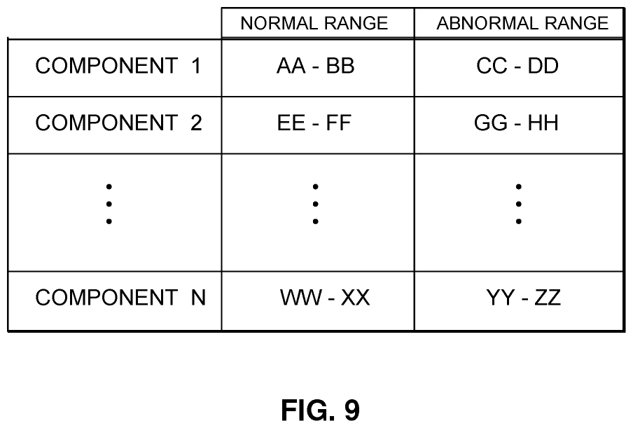

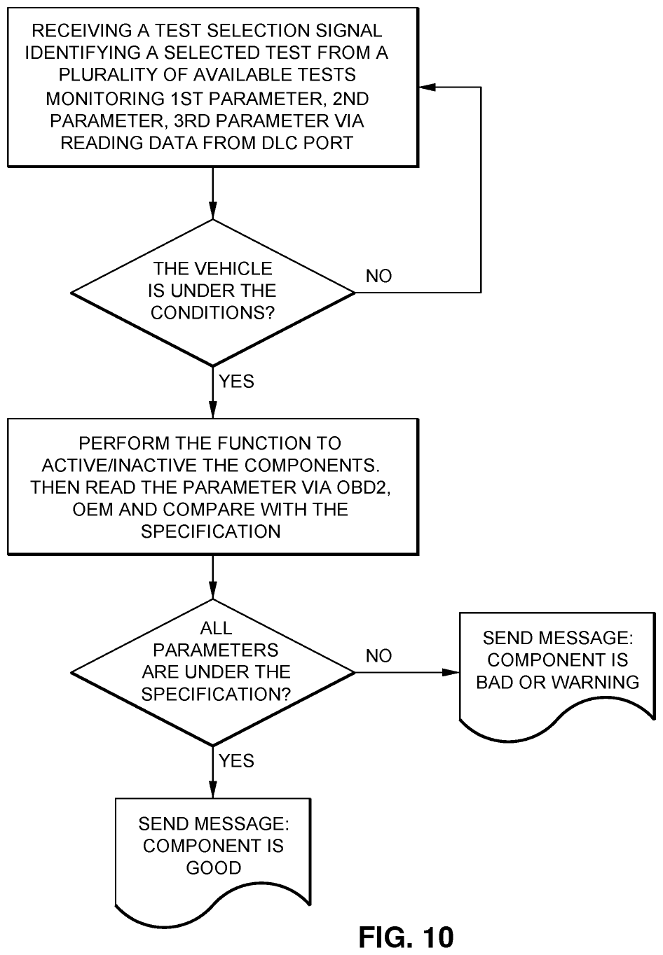

In addition to diagnostic analysis via the OBD2 data stream, and referring now to FIG. 9, it is contemplated that one or more vehicle components may be selectively activated/deactivated as part of further diagnostic analysis. The vehicle component(s) may be selectively activated to check for operability by measuring relevant parameter values on OBD2 PIDs and OEM PIDs.

The following example is provided to illustrate testing via an OBD2 data stream in combination with an actuator test. This example is associated with the following vehicle conditions: vehicle specific power (VSP) is 0 and the engine speed is less than 2000 RPM. For many CHRYSLER vehicles, the evaporative purge valve is transitioned to an off position, and the evaporative system vapor pressure is read. A command for an evaporative purge is sent and absolute evaporative system vapor pressure is read through OBD2 PIC, OEM PID within 10 seconds.

If the evaporative system vapor pressure does not change, a likely conclusion is that the valve is either inactive or may be clogged with dust or is damaged. If the evaporative system vapor pressure is increased and remains constant, the valve is likely in good condition. If the evaporative system vapor pressure increases and then subsequently gradually decreases, the valve is likely leaking.

For more information regarding the activation/deactivation/testing of specific components on the vehicle, please refer to U.S. patent application Ser. No. 18/328,289 entitled SYSTEM AND METHOD FOR GUIDED VEHICLE DIAGNOSTICS, the contents of which are expressly incorporated herein by reference.

While the foregoing describes use of the chart to identify possibly faulty components, which may subsequently be subject to selective actuation/deactivation for further confirmation, it is also contemplated that other aspects of the methodology may take into account environmental factors or operational factors when assessing the data. For instance, if the vehicle was driven uphill for an extended period of time, the expected data may be shifted to accommodate an above-average load being placed on the vehicle. Thus, one or more sensors may provide environmental input which may be assessed for shifting the expected data. It is contemplated that the sensors may be located on the vehicle and/or on the smartphone. The sensors may include a GPS sensor, a gyroscope, a temperature input (such as via a weather app located on the smartphone or via a thermometer on the vehicle), sound input (via microphone), etc.

In one embodiment, and referring now to FIG. 8, the optimal data may include a normal range of expected values and one or more abnormal ranges of expected values. The normal range may apply to most vehicles and driving conditions, while the abnormal ranges may apply to a limited number of vehicles or driving conditions. For instance, new vehicles may operate more optimally than the average-aged vehicle, and older vehicles may operate less optimally than the average-aged vehicle. Thus, newer vehicles may be subject to an abnormal range associated with better-than-normal expected values, while older vehicles may be subject to an abnormal range associated with worse-than-normal expected values.

The abnormal range may also be associated with environmental conditions, such as certain road grades (e.g., steepness), temperature, precipitation, air quality, etc. Each factor may be associated with one or more prescribed thresholds associated with an abnormal range of expected values. If the magnitude of a given factor warrants use of the abnormal range, the system 10 may use the abnormal range in the calculation.

The use of the abnormal range may allow for justifiable adjustment of the expected values, which may yield more accurate results when comparing to the data received from the vehicle 12.

It is understood that various functionalities described herein may be implemented or facilitated via a smartphone application (app.). In this regard, the smartphone app. may facilitate communications between the smartphone and the DAT, one or more remote resources (e.g., servers), and the vehicle. The app. may also facilitate monitoring and analysis of data on the smartphone and/or on the DAT. For instance, the instructions for data monitoring may be sent from the smartphone to the DAT. It is also contemplated that the smartphone app. may facilitate display of data on the smartphone, as well as implement one or more artificial intelligence functionalities associated with data analysis and decision-making on the smartphone.

It is contemplated that various aspects of the present disclosure may relate to optimization of a desired vehicle parameter, which may be operationally related to one or more related parameters. For instance, in the case of vehicle racing, it may be desirable to optimize certain parameters (e.g., air input, fuel injection, etc.) to achieve certain operational objectives, such as enhanced torque or increased top-end speed. In other instances, other parameters may be optimized to enhance vehicle responsiveness or handling. In the case of day-to-day driving, it may be desirable to optimize a parameter such as fuel consumption to minimize fuel costs as well as to reduce negative environmental impacts that may be associated with operating the vehicle. Thus, to achieve optimization of a desired vehicle parameter, adjustments to the related parameters may be made.

Various aspects of the present disclosure may be directed toward identifying the related parameters associated with a particular desired optimized parameter, as well as what types of adjustments may be implemented in connection with the related parameters to achieve a targeted value (e.g., optimization) of the desired parameter. That is to say, if someone wants Parameter A to be of a certain value (or within a range of values), adjusting Parameter B by an amount X and Parameter C by an amount Y may help to achieve that end. It is contemplated that the adjustments may be identified over a range of operating conditions.

In one particular embodiment, a machine learning model may be used to implement the optimization process. In this regard, a controller may apply the machine learning model to a set of vehicle data along with a targeted value for the desired parameter, with the output of the machine learning model being the value(s) for one or more of the related parameters. Such a machine learning model may be trained using historical data sets and historical adjustments to related parameters, as well as the actual effect on the desired parameter. By training a machine learning model with this kind of training data, the machine learning model may recognize, for a given set of related parameter data, which adjustments are the most effective and/or efficient to achieve a desired effect of the desired parameter data.

The particulars shown herein are by way of example only for purposes of illustrative discussion, and are not presented in the cause of providing what is believed to be most useful and readily understood description of the principles and conceptual aspects of the various embodiments of the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A diagnostic method for a vehicle, the method comprising the steps of:
receiving a test selection signal identifying a selected test from a plurality of available tests;
identifying multiple operating parameters associated with the selected test;
identifying prescribed operational conditions associated with the selected test;
receiving a first data set from the vehicle indicative of vehicle operating conditions;
comparing the vehicle operating conditions with the prescribed operational conditions to determine if the vehicle operating conditions comply with the prescribed operational conditions;
when the vehicle operating conditions comply with the prescribed operational conditions, receiving a second data set from the vehicle, the second data set including data associated with the multiple operating parameters associated with the selected test;
comparing the received second data set with an optimal data set to identify a portion of the received second data set that does not comply with the optimal data set; and
identifying a most likely solution based on the portion of the received second data set that does not comply with the optimal data set.

2. The diagnostic method recited in claim 1, further comprising the step of displaying a graphic depicting a relationship between the multiple operating parameters associated with the received second data set.

3. The diagnostic method recited in claim 2, wherein the graphic is displayed on a data acquisition and transfer device.

4. The diagnostic method recited in claim 2, wherein the graphic is displayed on a tablet computer.

5. The diagnostic method recited in claim 2, further comprising the step of incorporating a graphical depiction of the optimal data set on the graphic.

6. The diagnostic method recited in claim 1, wherein the identifying a most likely solution step includes identifying:
a first most likely solution when the portion of the received second data set that does not comply with the optimal data set is a first portion of the received data set, and
a second most likely solution when the portion of the received second data set that does not comply with the optimal data set is a second portion of the received data set.

7. The diagnostic method recited in claim 1, wherein the test selection signal is received from a user.

8. The diagnostic method recited in claim 1, further comprising the step of deriving the test selection signal based on a preliminary assessment of vehicle data.

9. The diagnostic method recited in claim 8, wherein the step of deriving the test selection signal is based on a comparison of the vehicle data to historical vehicle data.

10. The diagnostic method recited in claim 1, further comprising the step of deriving the test selection signal based on an algorithmic assessment of at least one of the following factors: vehicle data, a vehicle diagnostic condition, user input, PID data, at least one DTC, live data, and freeze frame data.

11. The diagnostic method recited in claim 10, wherein the step of identifying the test selection signal includes utilizing a mathematical model that considers one or more of the factors over a range of operational conditions.

12. The diagnostic method recited in claim 10, wherein the step of identifying the most likely solution is implemented through use of a mathematical model.

13. The diagnostic method recited in claim 1, further comprising the step of deriving the test selection signal based on a diagnostic assessment of vehicle data by an artificial intelligence tool.

14. The diagnostic method recited in claim 1, wherein the steps of identifying multiple operating parameters to identifying the most likely solution proceed autonomously in response to receipt of the test selection signal.

15. The diagnostic method recited in claim 1, wherein the steps of receiving the second data set to identifying the most likely solution proceed autonomously in response to determining the vehicle operating conditions comply with the prescribed operational conditions.

16. The diagnostic method recited in claim 1, further comprising the step of sending a signal to vehicle to cause a vehicle component to facilitate a desired action, the desired action being associated with an expected vehicle data output.

17. The diagnostic method recited in claim 1, further comprising the step of identifying the vehicle based on the data signal received from the vehicle.

18. The diagnostic method recited in claim 17, wherein the identity of the vehicle is determined based on an electronic vehicle identifying number included in the data signal.

19. The diagnostic method recited in claim 17, wherein the identity of the vehicle is determined based on information in the data signal identifying systems on the vehicle.

20. The diagnostic method recited in claim 1, wherein the step of receiving the test selection signal is implemented on a data acquisition and transfer device.

21. The diagnostic method recited in claim 1, wherein the step of receiving the test selection signal is implemented on a diagnostic server.

22. An automotive diagnostic method comprising the steps of:
receiving a data set from a vehicle, the data set including testing parameter data over a range of operating conditions;
comparing the testing parameter data to optimal data over the range of operating conditions and identifying portions of the testing parameter data that comply with the optimal data within a prescribed tolerance as being of an optimal health status and portions of the testing parameter data that do not comply with the optimal data within a prescribed tolerance as being of a non-optimal health status;
creating a graphic displaying the testing parameter data over the range of operating conditions;
creating a color scheme associated with the testing parameter data by assigning a first color to testing parameter data associated with the optimal health status and a second color to testing parameter data associated with the non-optimal health status; and
incorporating the color scheme into the graphic.

23. The automotive diagnostic method recited in claim 22, further comprising the step of displaying the incorporated color scheme and graphic on a display.

24. The automotive diagnostic method recited in claim 22, wherein the testing parameter data includes long term fuel trim data, and the operating conditions include RPM and throttle position.

25. The automotive diagnostic method recited in claim 22, wherein the step of creating the graphic includes creating a plurality of cells arranged in a grid having a first operational condition parameter associated with one axis of the grid and a second operational condition parameter data associated with another axis of the grid.

26. The automotive diagnostic method recited in claim 22, further comprising the step of sending a signal to the vehicle to cause a vehicle component to facilitate a desired action, the desired action being associated with an expected vehicle data output.

27. The automotive diagnostic method recited in claim 22, further comprising the step of identifying vehicle operating conditions associated with a diagnostic test.

28. A computer program product comprising one or more non-transitory program storage media on which are stored instructions executable by one or more processors or programmable circuits to perform operations for providing vehicle diagnostics, the operations comprising:
receiving a test selection signal identifying a selected test from a plurality of available tests;
identifying multiple operating parameters associated with the selected test;
identifying prescribed operational conditions associated with the selected test;
receiving a first data set from the vehicle indicative of vehicle operating conditions;
comparing the vehicle operating conditions with the prescribed operational conditions to determine if the vehicle operating conditions comply with the prescribed operational conditions;
when the vehicle operating conditions comply with the prescribed operational conditions, receiving a second data set from the vehicle, the second data set including data associated with the multiple operating parameters associated with the selected test;
comparing the received second data set with an optimal data set to identify a portion of the received second data set that does not comply with the optimal data set; and
identifying a most likely solution based on the portion of the received second data set that does not comply with the optimal data set.

29. The computer program product recited in claim 28, further comprising the step of displaying a graphic depicting a relationship between the multiple operating parameters associated with the received second data set.

30. The computer program product recited in claim 29, further comprising the step of incorporating a graphical depiction of the optimal data set on the graphic.

31. The computer program product recited in claim 28, wherein the identifying a most likely solution step includes identifying:
a first most likely solution when the portion of the received second data set that does not comply with the optimal data set is a first portion of the received second data set, and
a second most likely solution when the portion of the received second data set that does not comply with the optimal data set is a second portion of the received second data set.

32. The computer program product recited in claim 28, wherein the test selection signal is received from a user.

33. The computer program product recited in claim 28, further comprising the step of deriving the test selection signal based on a preliminary assessment of vehicle data.

34. The computer program product recited in claim 28, further comprising the step of deriving the test selection signal based on a comparison of the vehicle data to historical vehicle data.

35. The computer program product recited in claim 28, further comprising the step of deriving the test selection signal based on an assessment of the vehicle data implemented through use of a mathematical model.

36. A diagnostic method for a vehicle, the method comprising the steps of:
identifying a desired performance output for a first vehicle parameter, the first vehicle parameter being operationally related to a second vehicle parameter and a third vehicle parameter;
identifying a mathematical model that defines a relationship between the first vehicle parameter, the second vehicle parameter, and the third vehicle parameter;
using the mathematical model to identify a change in at least one of the second vehicle parameter and the third vehicle parameter value based on the desired performance output of the first vehicle parameter.
